(19) United States
(12) Patent Application Publication
(10) Pub. No.: US 2008/0162367 A1
(43) Pub. Date: Jul. 3, 2008

(54) System for networked media distribution

(76) Inventors: Robert Herry Pitzer, Tucson, AZ (US); Chris Harriman, Tucson, AZ (US); Michael J. Linnen, Waxhaw, NC (US)

Correspondence Address: Robert H. Pitzer, PO Box 8300, Tucson, AZ, 85738, US

(21) Appl. No.: 12/001,614

(22) Filed: Dec. 12, 2007

Related U.S. Application Data
(60) Provisional application No. 60/869,785, filed on Dec. 13, 2006.

(51) Int. Cl. G06Q 30/00; H04L 9/32; G06Q 10/00

(52) U.S. Cl. 705/76; 705/1; 705/14; 705/10; 705/26

(57) ABSTRACT

The present system provides a method and system for the distribution of electronic media content from a centralized operations center, also known as a Network Operations Center (NOC), through secure Internet network connections and Multimedia Dispensing Machines, also known as Entertainment Dispensing Machines (EDMs). The EDMs receive commands from the NOC to distribute media to be delivered with the delivery of an alliance partner's product or to be delivered to a customer in the vicinity of the EDMs. The media may be for purchase or rent. If for rent, the media is distributed from the EDM in a self-addressed and pre-paid return envelope that the customer uses to return the media in electronic format. Other embodiments are also described herein.

### CROSS-REFERENCE TO RELATED APPLICATION

This application claims the benefit of U.S. Provisional Patent Application No. 60/869,785 filed Dec. 13, 2006, the contents of which are hereby incorporated by reference.

### TECHNICAL FIELD

This description relates generally to media distribution and more particularly to methods and systems for networked media distribution.

### BACKGROUND

The distribution and return of entertainment media, such as, Digital Versatile Disks (DVDs) and Videos, is an inconvenient process for customers. Typically, customers have to travel to a video store located at an inconvenient location in order to rent as well as return the entertainment media. Therefore, customers often do not rent the entertainment media even when they have a desire to rent the entertainment media. Other online entertainment media distribution systems require that a customer request the titles of interest in advance before the titles are sent to the customer using mail or other delivery systems which also introduces a significant delay between the request and the delivery. Such a delay also is sub-optimal for the timely use of the entertainment media when desired by a user.

The system relates generally to a high technology integrated system for handling orders, order administration, order fulfillment, and return logistics for distinct and disparate industry products offered by specific alliance partners in a unified system. The system serves both alliance partners' consumer business models in a highly efficient and effective manner without requiring either of the alliance partners to enter the other's business, but rather simply leverage each other's market brand and strengths. An integrated host system provider operates a transaction-based system for the benefit of the alliance partners that results in good synergy and mutual benefit.

### BRIEF DESCRIPTION OF THE DRAWINGS

The accompanying drawings illustrate embodiments of the system and, together with the description, serve to explain the principles of the system.

FIG. 1 is a diagram that illustrates the process flow in certain embodiments of the present system.

FIG. 2 is network architecture diagram of certain embodiments of the present system.

FIG. 3 is a diagram that illustrates the functional flow architecture of certain embodiments of the present system that shows interaction between the media system's management system and alliance partners.

FIG. 4 is a diagram of a return envelop producer (“REP”) that can be used to implement certain embodiments of the present system.

FIG. 5 is another diagram of the REP that can be used to implement certain embodiments of the present system.

FIG. 6 is a diagram of the Entertainment Dispensing Machine (EDM) that can be used to implement certain embodiments of the present system.

FIG. 7 is a diagram of the physical or electronic connection between the EDMs 150 and the Network Operations Center (NOC) 200 that can be used to implement certain embodiments of the present system.

### DETAILED DESCRIPTION OF THE SYSTEM

In a general aspect, the present system provides an integrated transaction-based system that provides consumers with a rapid fulfillment demand order and reservation process for the supply of entertainment, educational, and other DVDs and/or videos, electronic games and music media, electronic books and magazines, and other similar products (collectively referred to as entertainment media or multimedia) that can be conveniently rented or sold to a customer. In certain embodiments, the rental (or sale) could be combined with fast food or quick service restaurant products for either customer pick-up or home delivery. Furthermore, in certain embodiments, the present system provides an easy mail-return of the rental entertainment media to the DVD (or other similar product) supplier distribution center.

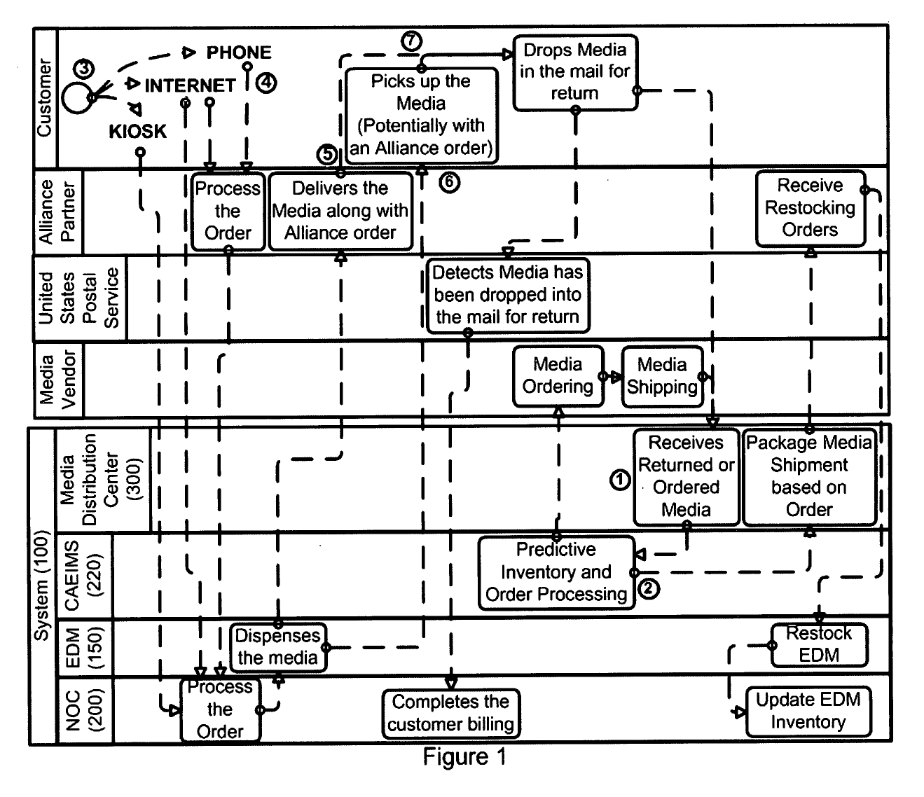

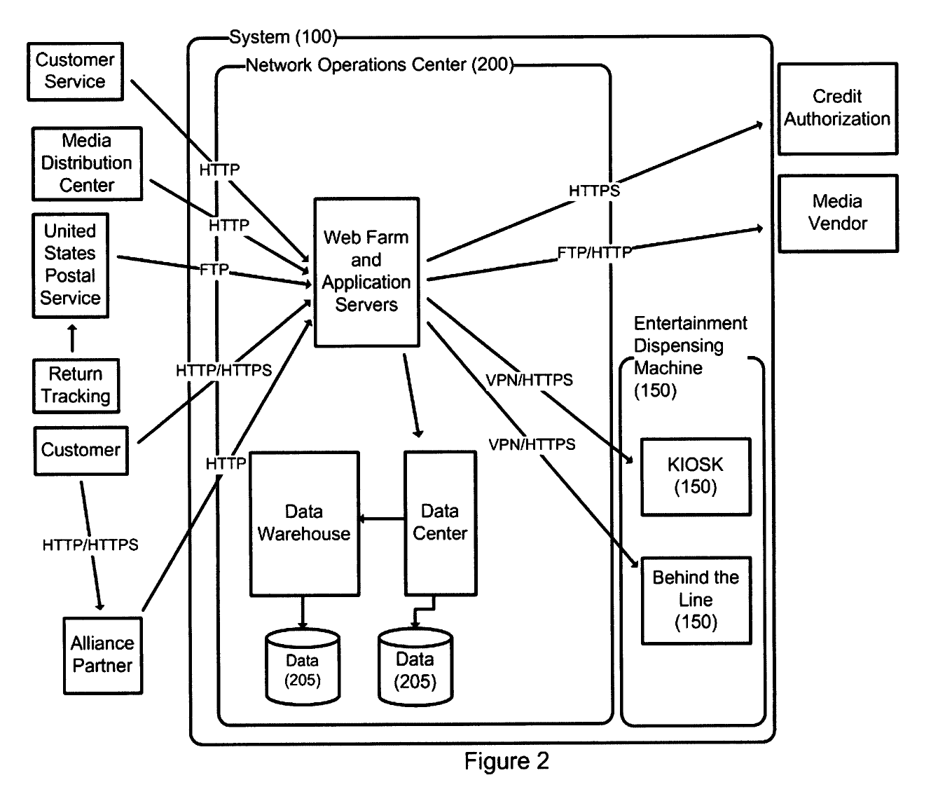

As shown in FIGS. 1 and 2, in certain embodiments, the system 100 of the present system comprises an extensive network of Entertainment Dispensing Machines (EDMs) 150, which dispense the entertainment media (or other similar products) under the remote command and control of the a Network Operations Center (NOC) 200 which is provided by the system 100. Each EDM 150 is networked via a network, such as the Internet over high-speed connections to the NOC 200. One skilled in the art would recognize that the network could also be any other public or private network or a virtual private network and could use wireline and/or wireless technologies to communicate between the different nodes of the network.

For certain embodiments, the process flow of the order fulfillment system is described in FIG. 1. As shown in steps 1 and 2, a Media Distribution Center (MDC) 300 on a systematic basis receives orders from the Cool Automated EDM Inventory Management System (CAEIMS) 220 that periodically stocks the EDM 150 with the DVD's (or other similar media products) and optionally communicates the stocking information to the NOC 200 where the NOC 200 may update a database 205 (shown in FIG. 2) which tracks the products available for distribution at the EDMs 150 and supplies the information to Internet ordering and to EDM location interfaces for walkup ordering where applicable.

In step 3 of FIG. 1, a customer makes a request for the DVD or product based on an individual EDM's inventory. The customer may make the request in one of three ways. First, as shown in FIG. 2, the customer may walk up the EDM 150 and use the EDM's user interface (if applicable, as some EDMs are not for direct customer use and, instead, are used in direct conjunction with a business partners Point of Sale system) to make the request and collect the requested DVD or product dispensed by the EDM 150. Second, the customer may call in through a call center that connects to the NOC 200, as shown in step 4 of FIG. 1. The call center supports the customer's request by either using an interactive voice recognition (IVR) or response (IVRR) device or through a live operator for the order of both the entertainment media products and the food orders. Third, the customer may order using a website that makes the request to the NOC 200 (FIG. 2). In each of the latter two cases, the DVD or product is available for pickup or delivery from a nearby EDM 150. If the EDM 150 is located at afood delivery location, the entertainment media and the food order may both be delivered by the food delivery location at the same time to the customer.

The nearby EDM 150 may be selected by the customer based on a location based selection by the customer, or system 100 may automatically determine the closest EDM 150 based on the customer's information (such as his address). The NOC 200 also has a database 205 so that information about the customer may already reside in the database 205 in the NOC 200. Some of the information about the customer stored in the database 205 could include the customer name and address as well as the customer's payment information (for example, credit card or checking account numbers and validation information).

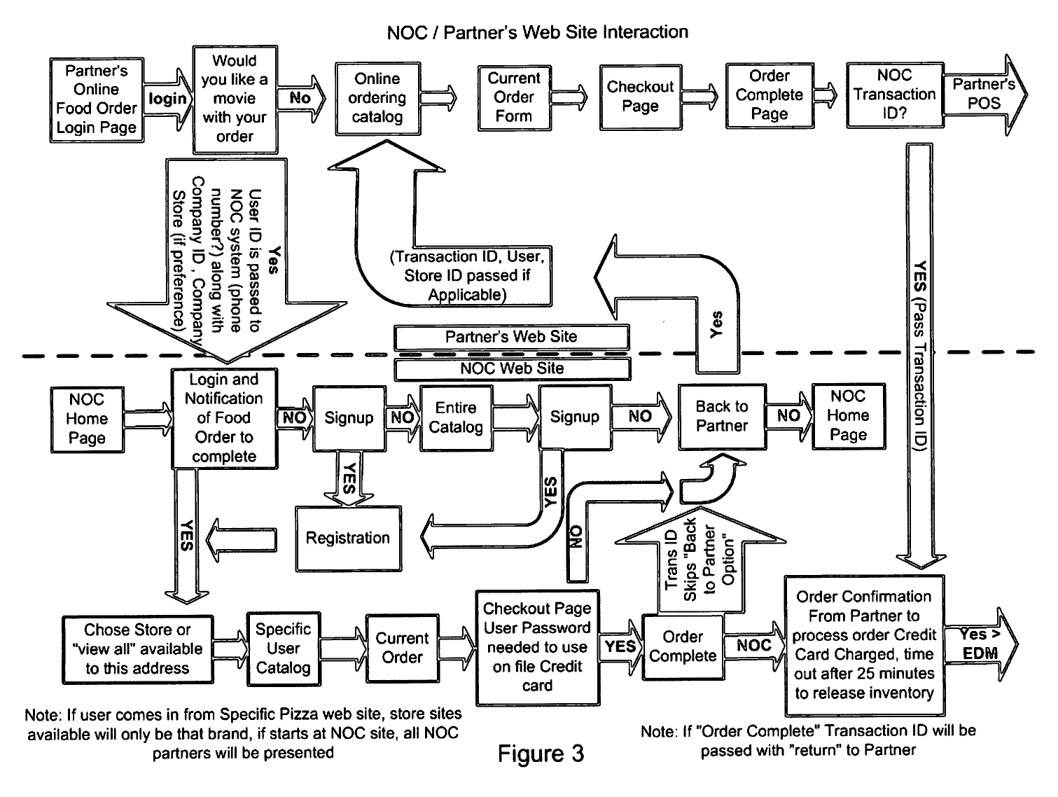

In certain embodiments, the DVD or product may be selected for delivery by a delivery service, such as a food delivery service as outlined in FIG. 3. The ordering system provided by certain embodiments of the present system will sequence the entertainment media and food orders to provide a discrete combined single order information ticket for export to the alliance partner's Point of Sale system. Therefore, the alliance partner's location, which can be where an EDM 150 is located, may efficiently combine and deliver both the food delivery or other order and the entertainment media order together (step 5 in FIG. 1). Alternatively, if the EDM 150 is located at the vendor location, the selected DVD or product may be collected from the EDM 150 located at the vendor location as shown in step 6 (FIG. 1). Therefore, food service vendor (or alliance partner) may then deliver (or hold for pickup) the DVDs or media products selected by the customer. To facilitate the coordination of the ordering of the service with the DVDs or media products provided by the system of the present system, the partner's service website or call center could be connected to the NOC 200 so that the orders for the DVDs or media products would flow through the NOC 200 which would then update the NOC 200 databases as well as issue any required management or control commands to the appropriate EDMs 150 and also provide the ordering information to the alliance partner's system (FIG. 3). After the customer then acquires the media (step 7 in FIG. 1), the customer will proceed to use it appropriately, and through this carefully monitored system the NOC (200) will be aware of how many days the customer has the media by subtracting the day the media was released to the customer (step 7) from the day the customer dropped the disk (or other media) in the mail to be returned to the MDC (step 1 in FIG. 1). In this action, the customer will only be charged for the days that he physically possesses the media, pursuant to an embodiment of the system.

In certain embodiments, the NOC 200 provides a wide variety of functions which are implemented by a computing system at the NOC 200. A functional architecture that discloses the typical functions implemented in the NOC 200 is disclosed in FIG. 2. As shown in FIG. 2. the applications software at the NOC 200 incorporates an integrated order system, which accepts orders for processing via an Internet Electronic-Commerce web site, a Professional Call Service Center or from the EDM 150 direct walk-up clients. The application can handle all customer order administration functions including credit/debit card processing, and through order fulfillment and media return logistics tracking. The NOC 200 can also perform all Inventory Management, Customer Account Management and EDM Network Operations through a series of databases that are systematically updated for each transaction.

In certain embodiments, the Entertainment Dispensing Machine (EDM) 150 is a computer controlled and servo-actuated media dispensing machine that is equipped with the following features.

(1) A Kiosk type user interface for the direct walk-up customers to select and order the desired DVD or other entertainment media via the graphical user interface, and pay via the credit/debit card reader on the machine or stored financial information.

(2) A multi-tiered carousel transport system for the load/unload operations together with a direct scan of media to facilitate inventory management during both the order and dispense cycle and the media reload process. In certain embodiments, individual stacks of disks will be loaded into a carousal slot. The disk type media will be print bar-coded or Radio Frequency IDentification (RFID) identified, and they will be machine scanned as they are moved internally in the EDM. The scanned information can be sent to a central location such as the NOC or will be stored locally by the EDM. The EDM may also be able to perform a self-inventory by scanning the location in each stack in each carousal bin where the bar-code or RFID is located. The disk type media is stored in paper or plastic sleeves that facilitate being able to be dispensed in mail type envelopes for mail return and protect the media during its storage and transport inside the EDM. The EDM facilitates movement of the physical media within the system through use of, for example, a pneumatic suction system that acquires physical media with vacuum to transport it to desired locations within the EDM.

(3) with a Kiosk type high resolution graphical display subsystem to provide high quality advertising to Alliance Partners for both Brand and Product advertisements. The display subsystem is dynamically controlled from within the EDM 150 and also remotely from the NOC 200 to provide an effective and efficient advertising program at each EDM 150 location that is so equipped and is targeted to that specific market while being administered centrally from the NOC 200. Therefore, the NOC 200 can communicate the specific advertisements to be displayed at each EDM 150 and can do so on an individual EDM basis or on the basis of all EDMs located at a certain location or at certain types of locations (for example, all EDMs located in a shopping mall). This also allows for targeted marketing to specific customers and allows the ability to provide different custom interfaces depending on the customer using the system.

(4) A printer subsystem (Return Envelope Producer or REP) to dynamically print and dispense the required media return mailer envelope together with the disk type rental media. The envelope contains the required information regarding the rental customer and the specific media rental to facilitate the pay-as-you-go mail-return process.

(5) Support a high capacity, for example, it is capable of handling more than 100 different disk titles for customer selection and has a total capacity in excess of 2000 disks to satisfy high demand locations.

(6) Includes an embedded microprocessor system running software and databases to command and control the EDM operations, perform secure and automatic inventory control, perform self maintenance diagnostics and automated load/unload service operations. Computer programmers can configure conventional software such as Microsoft Net products, which use standard Microsoft communication protocols, to control the EDM operations.

Some of the features of the system of the present system include the following:

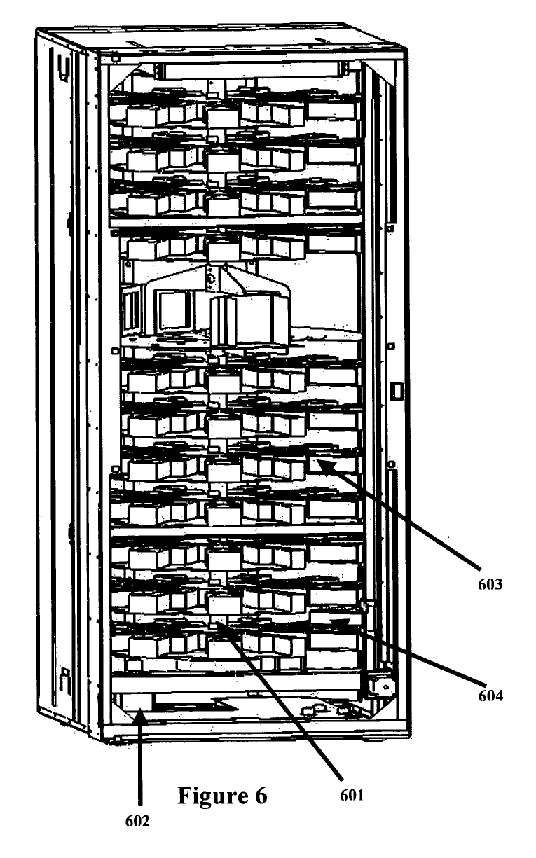

(1) The Entertainment Dispensing Machine (EDM) 150 that is designed to be an EDM of the NOC 200 and dispense products to a user according to FIG. 6. In certain embodiments, the EDM (or EDM) is a vending device for the purpose of dispensing a disk type format plastic disk or electronic media. It includes a mechanism with two axes for the simplicity of manufacture and reliability. The design includes multiple carousels on a common shaft 601 that can run up the center of the machine and that can be actuated by a common actuator 602. Each carousel 603 has 10 (for example) solid positive positions to store disks and one empty negative position to allow the transport arm 604 to pass by the carousel shelf, and each carousel 603 can also eliminate additional axes that could be subject to failure. The EDM also possesses sensors on the transport arm 604 that give it the ability to read graphical or radio frequency identifications on the disks for identification and verification reasons. The product inside the EDM is acquired onto the transport arm by means of a pneumatic vacuum system, which is utilized to make the transport system inside the EDM as versatile as possible (verses conventional mechanical means) for varying products the EDM might possess. Also disk type media inside the EDMs is stored in sleeve type envelopes to be able to maximize disk capacity within EDM size restraints and give the ability for the mail return solution. The overall EDM 150 width is based, for example, on being able to pass through standard commercial doors based on the Americans with Disability Act (ADA) standards. The overall EDM 150 is a networked device whose dispensing operations are controlled from a central Network Operation Center (NOC) 200 which verifies and processes order commands. In a kiosk configuration the EDM contains a touch screen that is an extension of the NOC, which is present for local ordering purposes. Also in a kiosk configuration, the device may contain a display monitor for the purpose of playing movie trailers and advertisement commercials. In a Behind the Line (BTL) configuration, the device lacks both the touch screen and display monitors and only contains a simple LCD status screen on the front cover to indicate device status, according to an embodiment of the system.

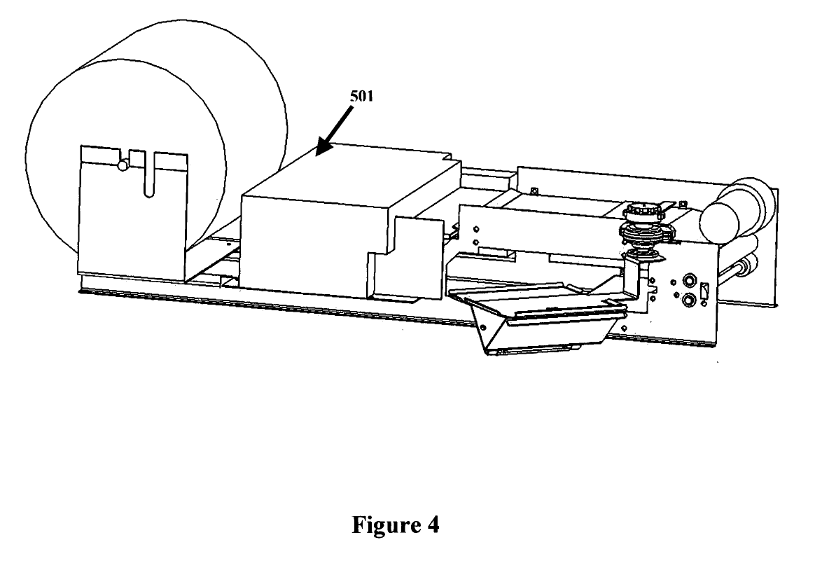

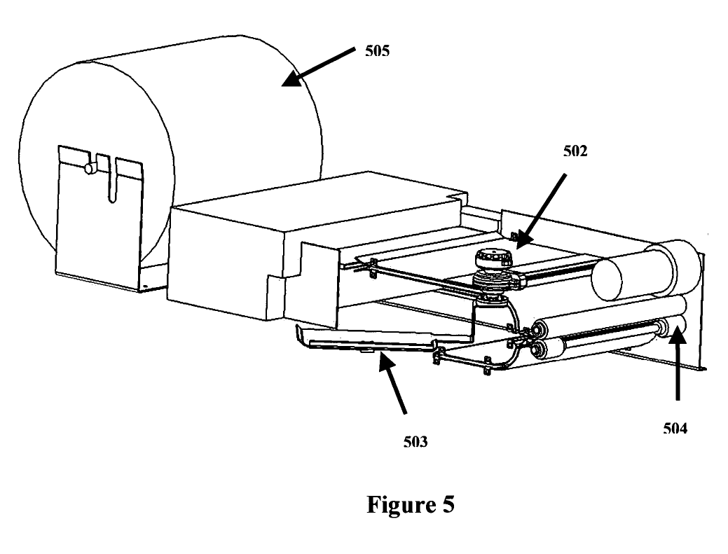

In certain embodiments, disk type media (or other similar products) are dispensed from inside of the EDM by a device called the REP (Return Envelope Producer) as according to FIGS. 4 and 5. FIG. 5 is the same as FIG. 4, but the side of the assembly has been removed for FIG. 5 to expose more of the assembly to facilitate operational explanation. In FIG. 5 the formed sheet metal guide is more obvious to understand how the REP guides the paper form around to be formed into an envelope. This device includes a printer and associated hardware to dispense the disks in a self-addressed stamped envelope that contains tracking information for inventory control of the media. The device has a high speed thermal printer 501 with a paper cutter that dispenses paper forms from rolled stock 505 while adding appropriate address information. The paper forms use cohesive gum technology to facilitate being “welded” together by the REP and also facilitate being able to be stored in roll form. The forms are directed through a sheet metal guide 502 that folds the paper back on itself. The disk type media from machine inventory is then inserted into the folded paper by means of a rotary pneumatic actuator arm 503 that receives the disk from the transport arm and is calibrated to force the disk into the folded paper and then into a set of pinch rollers 504 which then welds the paper into a mailable envelope using cohesive technology strips that are preprinted on the paper forms. As the folded forms are moved through the pinch rollers 504, the rollers impart sufficient force per square inch to sufficiently weld the particular cohesive technology together. This may vary slightly according to the cohesive technology used. The pinch rollers 504 then dispose of the disk and envelope into the outlet port of the EDM device.

(2) An electronic-Commerce web site that fully integrates the customer ordering of entertainment media and alliance partner's products such as food via the Internet, the Call Service Center or for the EDM direct walk-up customers. The website can operate as a single website whose databases are populated with data pulled from thousands of discrete outlets (i.e. EDMs) which is very different from the traditional approach of thousands of websites which support each individual outlet. It should be understood that the EDMs do not necessarily all dispense the same products from one supplier. Different EDMs could distribute different products from different vendors, respectively. Alternatively, a single EDM could have different products from different vendors. In each of these cases, pursuant to an embodiment of the system, the inventory and management information for the EDMs can be centrally stored at the NOC of the system and not separately at the different suppliers' facilities only.

(3) Incorporates a unique business process innovation to solve the pay-as-you-go media rental service model problem associated with mail-return of rented media. The present system can provide a specific method validated by the United States Postal Service (USPS) for postmarking a “No Postage Necessary” Business Reply envelope for mail-return tracking of specific media disks returned from the specific customer to the media distribution/service center (at the Media Distribution Center location 300, for example). Note that the use of the USPS is exemplary only since similar return mail tracking may be performed by using other mail services or private third party systems (for example, those used by the commercial package carriers) by printing postage directly on the paper forms that are dispensed from the REP. The mail-return solution, for pay-as-you-go media rental service, has never been used in any commercial enterprise. In one embodiment, a postmark is created for the “no-postage necessary” return envelope. The postmark is readable by the postal system machines so that a very accurate tracking of when a media or product is returned by a customer is kept. Furthermore, this data is verified by the system of a third party (the postal system) so that the customers would have very little basis for disputing their usage information since the exact return date would be verified by the system of a third party. The postmark would also be read by the Media Distribution Center so that return details of the products and the update of the inventory at the supplier distribution center can be easily and automatically performed.

In certain embodiments of the system. The EDM 150 may dispense the disks in envelopes with two addresses on it. The first address (outside) will be the mail “to” address in the case where media ordered from the EDM 150 is to be mailed to the customer. The second address (inside) printed by the EDM 150 on the envelope will be the return address for the mailed media to come back from the customer when they are finished with it. The tracking system will provide for tracking the media in the mail on both mailing occurrences so that the NOC 200 is aware the media is in transit and will have the ability to bill the customer only for the time that the media is physically in the customers' possession, pursuant to an embodiment of the system. This in essence will provide the owner of the EDM an automated mail order media rental system, which can be all self contained within the physical EDM 150.

In the following paragraphs, we discuss certain subsystems that implement various features provided in certain embodiments of the present system.

The NOC 200 operates on and is supported by a “Server Engine.” Running on the “Server Engine” are the following: (1) the “Electronic-Commerce Client Server Subsystem” which includes (a) the “Local Client Order System” and (b) the “Remote Client Order System.” This subsystem provides the media ordering system. It facilitates electronic commerce by using a single website that is populated with data pulled from thousands of EDMs into its database, compared to a traditional approach of thousands of websites for supporting each individual outlet.

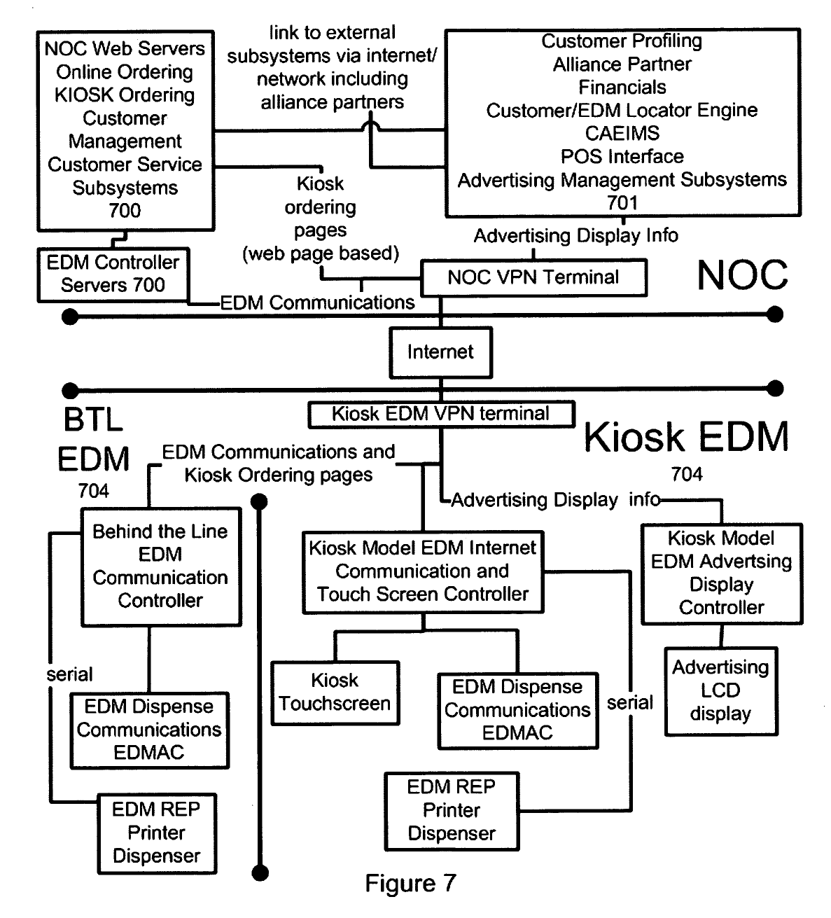

The “Customer Profiling Subsystem” (FIG. 7, reference number 701) provides the mechanism for tracking customer shopping habits for determining marketing strategies for increased sales and assist in providing information for marketing campaigns. This subsystem could also assist the CAEIMS subsystem (explained below) in its ability to predict inventory.

The “Customer Management Subsystem” (FIG. 7, reference number 700) provides the mechanism for registering and maintaining users in the NOC. The subsystem allows the user to set specific preferences that enable the user to navigate the site faster and find product that they wish to purchase or rent.

The “Customer Service Subsystem” (FIG. 7, reference number 700) provides the mechanism for operations to assist customers in their interactions with the System 100. This subsystem would enable the customer service representative to trouble shoot problems with the customer system 100 interactions. This subsystem also provides alerting mechanisms to signal technical health problems that arise within the System 100.

The “Customer/EDM Locator Engine Subsystem” (FIG. 7, reference number 701) provides the ability to identify customers within a specific geographic area. It links customers geographically with DVD and media inventory by querying inventory databases via network of disparate EDMs located within the geographic area.

The “Cool Automated EDM Inventory Management Subsystem” (CAEIMS) (FIG. 7, reference number 701) provides the ability to predicatively supply media and track the subsequent inventory of a nationwide network of EDMs. The CAEIMS determines the optimum inventory based on numerous factors including geographic location, predictive marketing data, and demographic make-up. Future EDM inventories are made up by a skilled person by applicable workweeks and demographic of where the EDM is located, and the future EDM inventories are stored in a NOC database as Preassigned Inventories (PI). On a weekly basis, the NOC automatically will compare the applicable EDM's Actual Inventory (AI) against its PI and order disks for that particular machine to be sent out by the MDC which will include additional disks to compensate for those that will be rented during shipping of the disks. This is accomplished by a predictive algorithm. Additionally, the EDMs will maintain a localized self-inventory for disaster recovery and other applicable usages. In some embodiments, this automated inventory manage method can be extremely important for this system as the possibility of tens of thousands of EDMs in the field would make it virtually impossible for a limited numbers of human operators to maintain, but the CAEIMS automated system makes it possible for the EDMs to actually be “restocked” by other machines, removing human operators from the overall system, thereby reducing cost and having the ability to maintain a large overall inventory inexpensively.

The “Alliance Partner Subsystem” (FIG. 7, reference number 701) provides a mechanism for tying partner systems into the Media rental/purchase business process. The subsystem gives the partner the ability to combine its order system with the NOC ordering system that becomes seamless to the end user. The subsystem gives reporting capabilities to the partner for determining sales of media items. If an Alliance Partner system does not currently exist, the system 100 will host an online ordering system for the partner. An example of this system is demonstrated by FIG. 3.

The “Network Operations Subsystem” (FIG. 7, reference number 700) can provide the ability to manage all operational activities of a nationwide network of EDMs, inventory databases, customer/member databases, Customer/EDM Locator Engine databases, audit databases, and food service product databases. It links these databases via a business process that involves predictive markets behavior, coupling of food and entertainment media orders, inventory management, a pay-as-you-go mail return process, and audit trail processing, and payment allocation, distribution and management.

The “Advertising Management Subsystem” (FIG. 7, reference number 701) provides the ability to identify, track, and manage advertising systems that are deployed by various business alliance partners. Advertising systems are managed and tied to specific EDMs and alliance partner web sites based on locations, market drivers and demographics. This subsystem coordinates, manages, tracks, provide services, and collects revenues within the overall network and business process provided by the present system.

The “Financial Clearing Processor Subsystem” (FIG. 7, reference number 701) can provide the ability to identify, track, distribute, reconcile, and archive all necessary financial transactions between media supplier partners, business alliance partners, and internal financial systems.

The “Retail Point-of-Sale Electronic Interface Subsystem” (FIG. 7, reference number 701) provides the ability to interface directly to the retail point-of-sale systems of business alliance partners. It is possible that unique business partners will have numerous disparate point-of-sale systems. This subsystem will manage the point-of-sale systems, linking and integrating them into the overall business process of integrating supply, ordering, and distribution of food and product orders with entertainment media sale and rental.

One skilled in the art would recognize that the foregoing describes a typical computer system connected to an electronic network. It should be appreciated that many other similar configurations are within the abilities of one skilled in the art and it is contemplated that all of these configurations could be used with the methods and systems of the present system. Furthermore, it should be appreciated that it is within the abilities of one skilled in the art to program and configure a networked computer system to implement the method steps of the present system, discussed earlier herein.

The distributed network of Entertainment Dispensing Machines (EDMs) (FIG. 7, reference number 704) for the distribution of rental media are under real-time control of the Network Operations Center (NOC), which can handle all order and fulfillment administration. Additionally, the NOC tracks and processes the media utilization characteristics, for management of the mail-return and directed redistribution plus the customer transaction closure and billings. For instances where communication is lost with the NOC, the EDM will complete dispenses that were already communicated to the EDM, but will wait for communication reestablishment with the NOC before more dispenses so that mail return and inventory management coordination can be performed. Upon lost communication, the NOC will set off alarms that its lost communication with the EDM as this could possible be a security issue. This will notify the appropriate personnel to check on the state of the EDM.

Each EDM, where the media is dispensed, is equipped with a high performance graphics printer, which prints the required information on the media rental mail-return envelope. The NOC order fulfillment processor correlates the customer order information with the EDM specific fulfillment information to create an encrypted encoding for the rental Transaction ID. That rental Transaction ID is sent to the printer for printing on the mail-return envelope along with other appropriate and necessary information. The rental transaction ID can be discreetly identified and tracked through the mail-return process of the USPS and redistribution center. Also the graphics printer may print transaction specific advertising, coupons or other graphical images on the dispense envelope depending on what is specified by the NOC.

The encrypted encoding for the rental Transaction ID specifically identifies the customer, individual order and the actual rental-disk barcode reference ID for the video or DVD dispensed plus other rental parameters. Any encrypted encoding system can be used.

When the mail-return envelope is placed into the USPS system, the postal service system equipment performs an immediate induction scan of the envelope containing the graphic that is coordinated with the rental Transaction ID and records the event for electronic access. When the NOC receives the induction record, a process is initiated to “stop the clock” and close the rental transaction.

The business process and system uniquely utilizes a capability within the Unites States Postal Service. A Barcode Format is used to imprint the unique encrypted graphic that is coordinated with the rental Transaction ID onto the address label area of the mail-return envelope, which is automatically scanned and recorded by the USPS equipment and then made available to the NOC for processing.

The EDM “Return Envelope Producer” (REP) Subsystem will print the proper mail-return Address Block information, including both the USPS Codes as stipulated by the USPS requirements document.

In some embodiments, an EDM may have a collator device incorporated to expedite the process of rapid dispense of media from the EDM. This will be in conjunction with Behind the Line EDMs being used with food delivery partners to help the employees quickly associate a media rental transaction with a food order transaction. The EDM can be compatible with a point of sale system where the collator device will aid in increasing efficiency of the organization utilizing the EDM with their order deliveries.

In association with food vender partners, the system may include providing the food vender partner with sleeve type attachments that attach to the food partners delivery apparatus (such as a pizza delivery insulation pouch or a pizza box) to facilitate associating media delivery orders with a particular food delivery order. The media delivery order would be placed in the sleeve to make sure it is delivered with the appropriate food order to avoid possible mistakes being made where multiple food orders are being delivered by the same personnel at the same time. The sleeve can be a simple pocket that can attach temporarily or permanently to the alliance partners delivery apparatus.

In certain embodiments of the system, the Kiosk EDM may contain a “fast lane” to facilitate customers who reserve media from the particular machine remotely and just have to present their identification at the machine to pick up their media. The customer would arrive at the machine and log in using their identification, and the machine would dispense their media without an option to browse for more media in the EDM through use of the EDM touch screen.

Although the aforementioned describes embodiments of the system, the system is not so restricted. It will be apparent to those skilled in the art that various modifications and variations can be made to the disclosed certain embodiments of the present system without departing from the scope or spirit of the system and all such variations and modifications are considered to be a part of the present system.

1. A system for distributing multimedia to users, the system comprising:
a network of Entertainment Dispensing Machines (EDMs) in different locations and having the multimedia; and
a Network Operations Center (NOC) that controls the network to distribute the multimedia to the users.

2. The system of claim 1 where:
the EDMs distribute the multimedia on Digital Versatile Disks (DVDs), on Compact Disks (CDs), over one or more wireless networks, or over one or more wired networks;
the multimedia are to be distributed for sale or rent; and
the EDMs are accessed either remotely by the Internet or telephone, or locally at the location of the EDM.

3. The system of claim 1 where:
the multimedia are distributed from the EDMs on Digital Versatile Disks (DVDs), on Compact Disks (CDs) for rental by the users;
the EDMs further comprises a Return Envelope Producer (REP) to dynamically generate transaction specific envelopes; and
the multimedia are packaged in the transaction specific envelopes and are tracked by the system after or while being returned from the users.

4. The system of claim 1 where the EDMs distribute the multimedia on digital command from the NOC.

5. The system of claim 1 where the EDMs operate semi-autonomously by taking local control to protect the multimedia by EDM lockdown if communication with the NOC is lost.

6. The system of claim 1 where the EDMs communicate through the Internet with the NOC through a secure Virtual Private Network (VPN) connection.

7. The system of claim 6 where the EDMs are replenished with the multimedia by electronic file transfer over the VPN connection or by shipping digital versatile disks or compact disks from a disk resource center.

8. The system of claim 1 where the EDMs comprise a Return Envelope Producer (REP) that dynamically creates transaction specific return envelopes, and where the EDMs dispense digital versatile disks or compact disks in the transaction specific return envelopes when the digital versatile disks or compact disks are rented by the users.

9. The system of claim 8 where the transaction specific return envelopes dispensed from the EDMs containing the digital versatile disks or the compact disks rented by the users are prepaid for postal delivery.

10. The system of claim 8 where the REP comprises a printer and a subsystem to receive the output of the printer, and where the subsystem modifies the output of the printer to create the transaction specific return envelopes into which the digital versatile disks or the compact disks are inserted before being dispensed out of the EDMs to be rented by the users.

11. The system of claim 8 where the EDMs print text on the transaction specific return envelopes, and where the text is specific to the users' individual transactions and comprises at least a coupon or product information.

12. The system of claim 8 where the EDMs comprise a roll of forms used to create the transaction specific return envelopes.

13. The system of claim 1 where the EDMs comprise a Return Envelope Producer (REP) that creates transaction specific return envelopes, and where the EDMs dispense digital versatile disks or compact disks in the transaction specific return envelopes when the digital versatile disks or compact disks are rented by the users, and where the system further comprises sleeves that hold the transaction specific return envelopes from the EDMs and that attach to an alliance partners' delivery apparatuses.

14. The system of claim 1 where the NOC interfaces with alliance partners by utilizing Internet protocols to coordinate the EDMs' dispensing of the multimedia with orders from the alliance partners' point of sale systems.

15. The system of claim 1 where the EDMs comprise an interface coupled to the NOC through a secure Internet connection, and where a first one of the users in a vicinity of a first one of the EDMs interacts with the NOC through the interface of the first one of the EDMs.

16. The system of claim 1 where a first one of the users in the vicinity of a first one of the EDMs verifies the first one of the users' identity for the first one of the EDMs by use of a biometric security device, the first one of the users' credit card, or a system electronic key.

17. The system of claim 1 where a first one of the users receives the multimedia from one of the EDMs, and where the first one of the users returns the multimedia to the system by using the United States Postal Service (USPS).

18. The system of claim 1 where the system automatically restocks the EDMs with replenishment multimedia by monitoring the EDMs and automatically sending the replenishment multimedia to the EDMs based on forecasted future inventories.

19. The system of claim 1 where the users utilize the system to order the multimedia by using the Internet to access the NOC.

20. The system of claim 1 where at least a first one of the users interfacing with the system through the Internet does so through an individualized interface customized specifically for the first one of the users.

21. The system of claim 1 where at least a first one of the users reserves at least a first one of the multimedia for rent over the Internet from a first one of the EDMs and picks up the first one of the multimedia from the first one of the EDMs at a later time.

22. The system of claim 1 where the EDMs comprise a pneumatic handling system to move media products within the EDMs.

23. The system of claim 1 where the system further comprises a mail return subsystem, and where the multimedia comprises multimedia disks, and where the EDMs comprises a multi tier carousel storage system configured to store the multimedia disks in disk sleeve type envelopes to be used in conjunction with the mail return subsystem.

24. The system of claim 1 where the multimedia comprises disks, where the system comprises a mail return subsystem, and where the disks are stored in disk sleeve type envelopes inside the EDMs to be utilized with the mail return subsystem.

25. The system of claim 1 where the multimedia comprises media disks, and where the system further comprises an automated mail order media system that stores, inventories, and prepares the media disks to be distributed to and returned from the users, where the EDMs and the NOC form portions of the automated mail order media system, and where the NOC keeps track of the users' time of possession of the media disks to calculate rental fees for the users.

26. The system of claim 1 where at least a first one of the EDMs comprise a fast lane customer interface for the users who have preordered at least a first one of the multimedia from the first one of the EDMs and who are arriving at the first one of the EDMs to retrieve the first one of the multimedia.

27. The system of claim 1 where the EDMs dispense the multimedia to be rented by the users in mailers, and where each of the mailers are pre-addressed to be mailed to more than one address.
